(19) United States
(12) Patent Application Publication
(10) Pub. No.: US 2013/0167185 A1
(43) Pub. Date: Jun. 27, 2013

(54) System and Method of Multiple Context-awareness for a Customized Cloud Service Distribution in Service Level Agreement

(71) Applicant: Konkuk University Industrial Cooperation Corp., Seoul (KR)

(72) Inventors: Han-ku LEE, Seoul (KR); Hyo-Gun Yoon, Daejeon (KR)

(73) Assignee: KONKUK UNIVERSITY INDUSTRIAL COOPERATION CORP., Seoul (KR)

(21) Appl. No.: 13/685,882

(22) Filed: Nov. 27, 2012

(30) Foreign Application Priority Data
Dec. 26, 2011 (KR) 10-2011-0142658

(51) Int. Cl. H04N 21/643

(52) U.S. Cl. CPC H04N 21/64322
USPC 725/109

(57) ABSTRACT

This disclosure relates to a system for performing multiple context-awareness to distribute customized cloud services under a service level agreement, and relates to a method for the same. Specifically, the system and method for performing multiple context-awareness to distribute customized cloud services under a service level agreement provide customized cloud services in accordance with the determination of a service level agreement (SLA) and of a cloud service complying with the agreement so as to reliably process services in open architecture.

### CROSS-REFERENCE TO RELATED APPLICATION

This application claims priority to Korean Patent Application No. 10-2011-0142658, filed on Dec. 26, 2011, and all the benefits accruing therefrom under 35 U.S.C. §119, the contents of which in its entirety are herein incorporated by reference.

### BACKGROUND

1. Field

This disclosure relates to a system for performing multiple context-awareness to distribute customized cloud services under a service level agreement, and relates to a method for the same. Specifically, the system and method for performing multiple context-awareness to distribute customized cloud services under a service level agreement provide customized cloud services in accordance with the determination of a service level agreement (SLA) and of a cloud service complying with the agreement so as to reliably process services in open architecture.

2. Description of the Related Art

As cloud computing services have been recently developed, there are demands for service structures customized for individuals. Customized services require user context information to provide a customized service for a user, and such information can be collected using a service device connected to internet. The analysis of user context information by a user's service device shows a big difference from the analysis of context information in a server. For example, when the analysis of such information is performed concurrently with other processes in a smart phone, the service speed is lower due to multiple data processing while the analysis is performed on a background.

Korean Patent Application No. 2011-0097434 discloses a system and method for providing cloud services in a limited way when a terminal device is not connected to Internet. The system and method allows a terminal device having no internet access to be associated with a cloud service through a terminal device having a connection to internet.

Korean Patent Application No. 2011-0118292 relates to a system for providing television services by means of cloud computing and smart phone control. The system provides streaming and encoding services with respect to various codecs by connecting a cloud server to each set-top box at home through network, so that a variety of services which used to be available only on personal computers or in mobile environment can be implemented on televisions and controlled by means of a smart phone. The system also provides high-end services even with a set-top box having a low-end hardware or software.

### SUMMARY

The present disclosure provides a method for distributing cloud services, which are provided to individuals, under a SLA, and provides a cloud computing service customized for individuals that uses a multiple context-awareness technology and is ubiquitous regardless of the kind of a user's terminal device.

To accomplish the purposes stated above, the present disclosure includes a packet module constituting a packet for providing the context information of a user; a data managing module for using the context information received from the user and managing the service information determined, and for classifying and managing the context information of the user; a user context information classifying module for classifying and analyzing the context information transmitted from the user; a context defining module for defining the context information as validated data; a SLA defining module for defining a service level that suits for the context information; and a virtualization module for providing the user with a service item that has been selected by constituting a cloud virtualization service.

The present disclosure can further include a mass data distribution managing module for managing, in real time, the context information and image data of the user that have been served.

The present disclosure can further include a service recognizing module for recognizing a service status with the analyzed context information of the user and selecting a service item.

The present disclosure can further include a user image converting module for recording the use level of the customized cloud service that is provided as virtualized and for converting it to an image; and a service transmitting module for transmitting data including the virtualized cloud service to the user device.

The present disclosure can further include a service event recognizing module for recognizing the movement of a user using such a device as a keyboard, a mouse, or a touch device that arises from the operation of the cloud service.

The context defining module according to the present disclosure includes a relationship defining module for defining the relationship between context information classified to infer the user context; a meaning analyzing module for extracting priority data, which affect service behaviors, by analyzing the relationship resulting from the context information; and a domain mapping module for inferring the service behaviors that can exist in the user context data and for mapping the information.

The SLA defining module includes a service level defining module for defining, and symbolizing, the service structures level by level that result from the user context information; an instance data analyzing module for analyzing the information of a service software that results from the cloud server and of the data structure used; and a software matching module for connecting a service software that suits the user context from the cloud server.

The present disclosure includes collecting and providing, through a packet module, the context information of a user; encoding and decoding, through a encoding/decoding module, the packet transmitted; managing, through a data managing module, the service information determining by using the context information received from the use, and classifying and managing, through the data managing module, the context information of the user; classifying, a user context information classifying module, the context information transmitted from the user for analysis; defining the context information as validated data through a context defining module; defining a service level that suits for the context information through a SLA defining module for; and providing, through a virtualization module, the user with a service item that has been selected by constituting a cloud virtualization service.

The present disclosure can further include recognizing a service status with user context information analyzed and selecting a service item, through a service recognizing module.

The present disclosure can further include recording, and converting into an image, through a user image converting module, the level of the use of the customized cloud service provided as virtualized; and transmitting it, through a service transmitting module, to a service device with the virtualized cloud service incorporated.

The present disclosure can further include recognizing, through a service event recognizing module, user's movement associated with the operation of such a device as a keyboard, a mouse or a touch device, which arises from the use of the cloud service.

The present disclosure can further include defining, through a relationship defining module, the relationship between classified context information in order to infer the context of the user; extracting, through a meaning defining module, data having priority, which affects service behaviors, by analyzing the relationship generated from the context information; and inferring, through a domain mapping module, the service behaviors that can exist in the user context data and mapping the information.

The present disclosure can further include defining, and symbolizing, through a service level defining module, the service structures level by level that result from the user context information; analyzing, through an instance data analyzing module, the information of a service software that results from the cloud server and of the data structure used; and connecting, through a software matching module, a service software that suits the user context from the cloud server.

The present disclosure allows a user of a cloud computing system to ubiquitously use a customized cloud service that suits the user, regardless of the type of the user's terminal device, so long as being connected to Internet. The user can enjoy the best service that he/she wants because the user receives a cloud service that fits the user's context.

Also, the present disclosure can apply to a variety of service models and constitute the optimized service that complies with a user's SLA. Consequently, the present disclosure can provide an interface with which a user can use services by intuition. Furthermore, the method of analyzing the context information of a user according to the present invention is also applicable to an analysis model for developing a new cloud service and to a service model for determining a user's service status.

The present disclosure can help organizing services according to a service target, and assisting the cost required to organize cloud infrastructures, platforms and software services.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a block diagram generally illustrating a method of a multiple context-awareness for distributing customized cloud services under a SLA according to the present embodiment herein;

FIG. 2 illustrates packets for distributing the context information and use-pattern of a user;

FIG. 3 illustrates an encoding packet for safely transmitting the context information of a user;

FIG. 4 illustrates a process of encoding and transmitting the context information, and a process of recognizing multiple context data;

FIG. 5 illustrates a process of defining and analyzing the multiple context-awareness information;

FIG. 6 illustrates a process of defining a SLA and determining a cloud service; and

FIG. 7 illustrates a process of managing the context data of a user, which is used in a cloud server.

### DETAILED DESCRIPTION

Exemplary embodiments are described more specifically with reference to the accompanying drawings. The same reference numerals denote the same elements throughout the drawings. In particular, “data” and “information” has been interchangeably used depending on the context. When the present invention is illustrated, the details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Generally, the development of cloud computing can only need an internet connection to provide a mass data service, and thus provide a user with the service that the user wants everywhere. However, a variety of analytic methods are required to indentify the service status of a user, and such methods include analyzing the type and mobility of a device, observing the network status, the method of encoding or decoding, and the policy for determining the service level.

For this purpose, the context-awareness technology is required, and the SLA analysis model is necessary to provide a service policy that complies with a user level. The analysis method for recognizing user context information and determining a cloud service suitable for the user's device utilizes an ontology, which analyzes the meaning of each of information recognized.

Context information includes the personal information of a user, the information of a service-use pattern, the information of a user device, location information, and a keystone for security. This information is refined into two-level structures to acknowledge a user's context, and determine a cloud software suitable for the context, which is incorporated into a individually-customized cloud virtualization technology.

The distribution of such customized cloud services is determined by the accuracy and correctness of the analysis of user context information. It also requires a technology for quickly analyzing mass data with real-time processing contained in a cloud computing system. Thus, a cloud computing service under a SLA can provide customized cloud services by accurately recognizing context information inputted in a variety of patterns.

As illustrated in the following embodiments, the present disclosure can perform, at the same time, recognizing the service used by a user in real time and monitoring the service-use pattern and performance. It is important to provide a quick structure for each of many users in order to analyze the context for determining a cloud service customized for each user, and to provide services with a designated level. Therefore, it is required to provide a method for immediately analyzing user context information and determining the service level for a user.

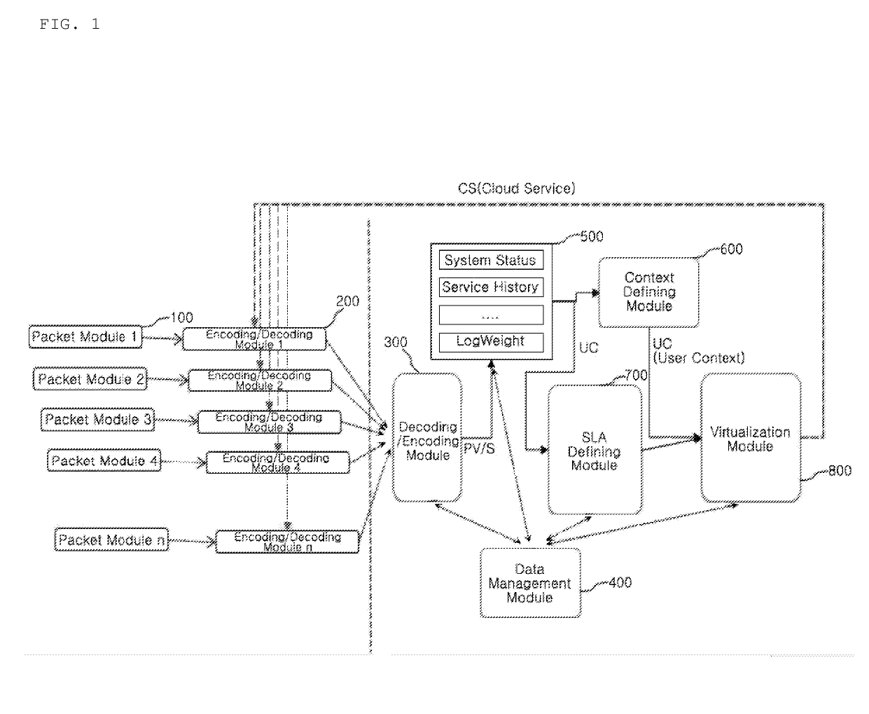

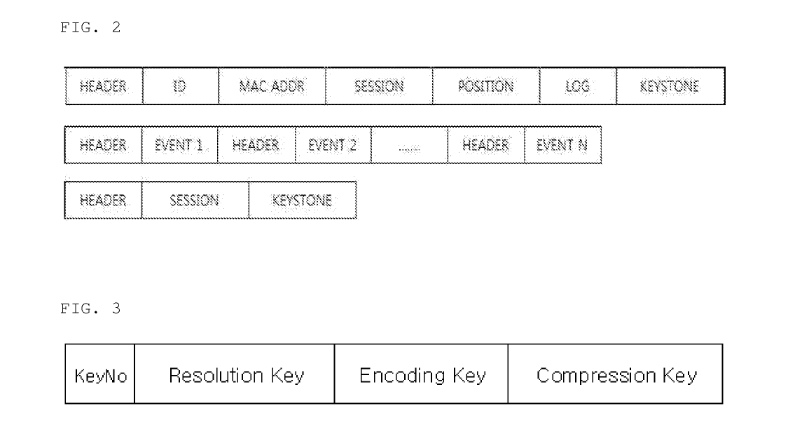

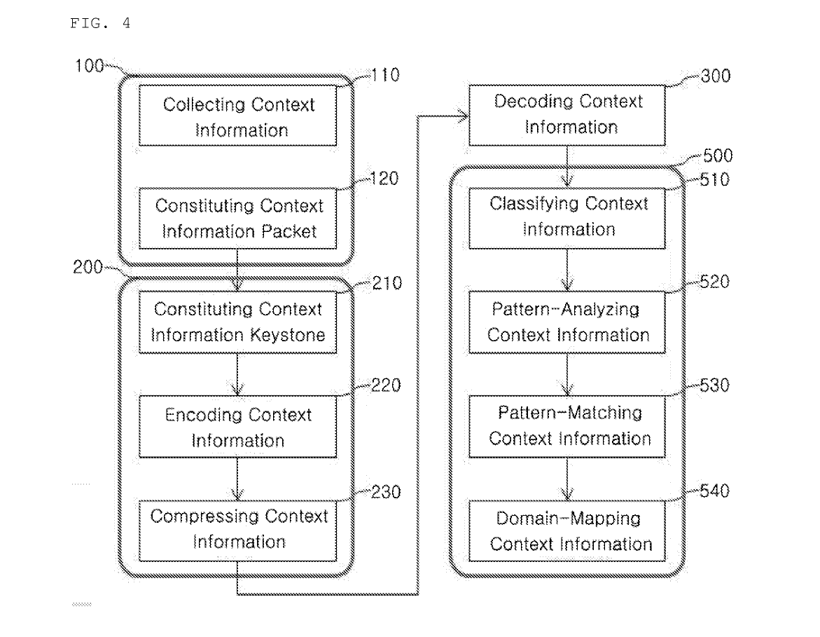

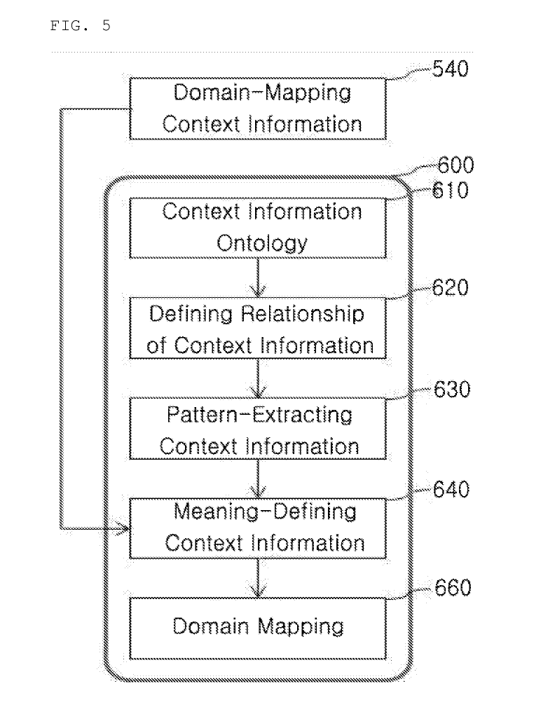

For these purposes, as illustrated in FIGS. 1-4, the present invention can include packet modules 100 each for constituting a packet to provide user context information, encoding/decoding modules 200, 300 for encoding and decoding the packets transmitted, a data management module 400 for applying the context information received from the user to the step of analyzing the context and for classifying the user context information for management, a user context information classifying module 500 for classifying the user context information to analyze the context information transmitted to the user, a context defining module 600 for defining the context information as validated data, a SLA defining module 700 for defining a service level that suits for the context information, and a virtualization module 800 for providing the user with a service item that has been selected by constituting a cloud virtualization service.

The present invention can further include a mass data distribution managing module for managing, in real time, the user context information and image data that have been served.

The present invention can further include a service recognizing module for recognizing a service status with the analyzed context information of the user and selecting a service item.

The present invention can further include a user image converting module for recording the use level of the customized cloud service that is provided as virtualized and for converting it to an image, and a service transmitting module for transmitting data including the virtualized cloud service to the user device.

The present invention can further include a service event recognizing module for recognizing user's movements in a keyboard, a mouse, or a touch device, etc., which arise from the operation of the cloud service.

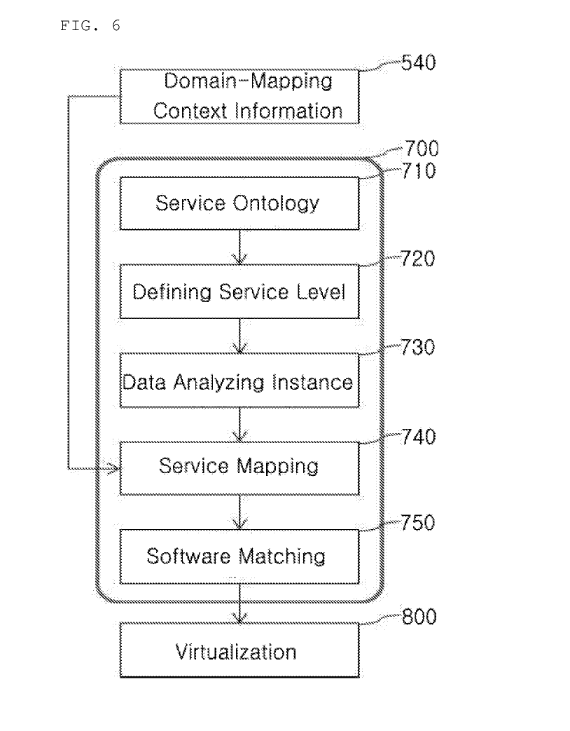

As illustrated in FIG. 5, the context defining module 600 can include a relationship defining module 620 for defining the relationship between context information classified to infer the user context, a meaning analyzing module 640 for extracting priority data, which affect service behaviors, by analyzing the relationship resulting from the context information, and a domain mapping module 660 for inferring the service behaviors that can exist in the user context data and for mapping the information.

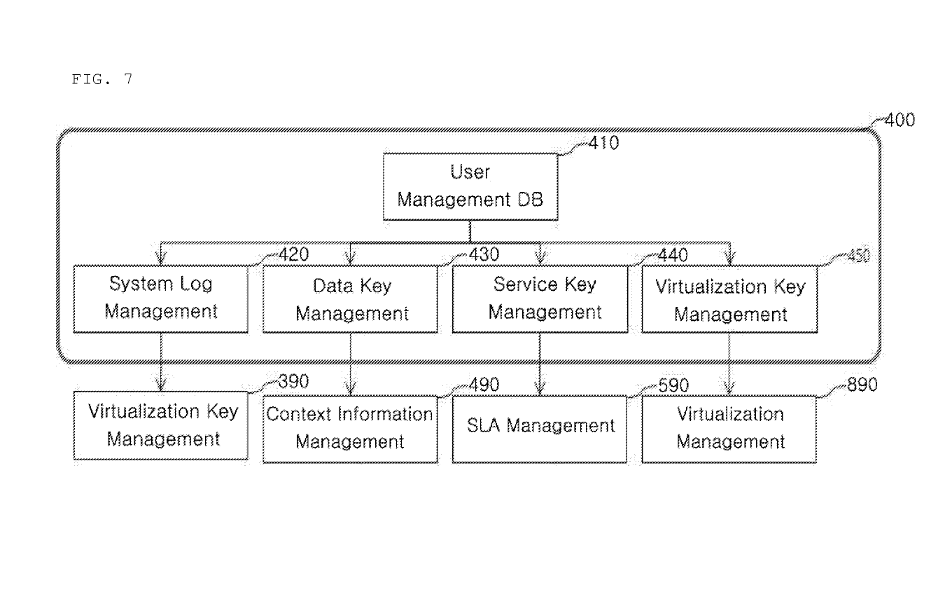

As illustrated in FIG. 6, the SLA defining module 700 can include a service level defining module 720 for defining, and symbolizing, the service structures level by level that result from the user context information, an instance data analyzing module 730 for analyzing the information of a service software that results from the cloud server and of the data structure used, and a software matching module 750 for connecting a service software that suits the user context from the cloud server.

Specifically, the packet information that constitutes user context information for the distribution of customized cloud services according to the present invention requests a cloud service, using a user device connected to the Internet, and then constitutes a packet containing the information necessary for connection and service.

IDs and MAC addresses are identified to secure the independence of a user in the cloud service, and the duplication of the same cloud services is allowed by setting up the option for a duplicate connection.

This duplication is allowed by identifying the meaning of the duplicate access, which was set up as an option, with the information of MAC addresses and sessions, when a user with a duplicate ID accesses the same service.

Then, with the information of a user device identified, the position data having the information of a user's location, and the service log regarding the previous accesses, are identified, and incorporated in a packet.

Also, a keystone is included to secure data safety and to prevent leakage of personal information. When the information of a session, which is connected, is transmitted from a cloud server, action events of a user, such as input/output events with a keyboard, a mouse and a touch device, etc., resulting from the use of a service are transmitted before the close of the packet.

A method for encoding the context information of a user according to the present invention can encode, with the DES algorithm, the keys consisting of a compression key, a encoding key, and a KeyNO registered as the serial and the interface resolution of the user device.

Each key value has distinct user information, and maintains a certain status while being stored in a cloud server with the user information previously registered.

Such key values include images, and rely on a method by which, when certification fails, a new certification image is suggested to a user, and a keystone is constituted by restructuring the answer to the suggested one.

The context information classifying module 500 according to the present invention transmits user context information, which is constituted as a packet, together with a keystone in encoding compression. Accordingly, the structures of context information are different by users, and it is thus important to classify them.

First, the context information is identified by decoding the encoded context information transmitted. The keystone information can classify the context information having multiple structures, and steps for identifying the meaning of each of the context information are performed. Each of context information classified runs through a process of comparing the previous context information and the current context information in order to analyze a pattern. An operation that matches the behavioral pattern of a user pre-defined by the pattern analysis is performed. By so doing, the relationship information of a status of a similar user behavior is identified and a domain necessary for a service is mapped.

The context defining module 600 according to the present invention performs an analysis of meaning of user context information, using domain mapping information associated with the context information. For this purpose, an ontology model is incorporated to classify context information, and the information constituting the ontology is made up of the standardized information of a user.

Using the ontology defined as such, the relationship with respect to user context information is identified, and the definition of context information having a high correlation is achieved.

Because each of the context information has a certain relationship, a pattern that is required for matching user's services can be extracted.

And, using the extracted pattern information and the mapped domain information, the meaning of the user context information is analyzed.

Then, a step of mapping the analyzed meaning information with the user context information is performed. The data developed as such can identify the level of the user's use of services.

The SLA defining module 700 according to the present invention performs mapping the service information that suits a user's device and context, and thus matching a necessary software. For this purpose, a cloud service that can be used by a user is constituted as an ontology and mapped with context information. Furthermore, the service information extracted from the ontology defines the status of use based on a use's pattern of use. This definition defines the information of level based on the previous service log. Then, the instance information of cloud resources necessary for each service is identified, and the status of necessary information is analyzed. As a result, a safe instance can be called, and the integrity of data can be secured. The information analyzed as such determines services by using the context information of a user and the mapped domain. And, depending on the service determined, a virtualization is established by incorporating a software, and is provided to a user as a cloud service. The cloud service provided is made as an image and managed by a data managing module.

As illustrated in FIG. 7, the context data managing module 400 is managed to maintain in a certain level the data generated in each of modules. For this purpose, each of user data has a key and data value, is managed separately as four data areas, i.e., system log management 420, data key management 430, service key management 440, and virtualization key management 450. The system log management manages the information of an encoding status, the information of a service transmission status, and the information of a user's connection status generated in the encoding/decoding module of a cloud server. The data key management constitutes the context information of multiple users as the ID key of a connecting user, and manages the input context information in a compressed state. The service key management manages the software information and the service definition under a SLA provided to a user by granting the same key value as the context information of the user. Furthermore, the virtualization key management classifies, by keys, mass virtualization information that has been constituted to suit a user. The information constituted as such requires a systematic management and can provide a cloud service that suits a user's context.

As such, the present invention provides a system for analyzing a variety of user context data to provide an individual user with a customized cloud service under a SLA. The system extracts the information of a meaning necessary for a service from user context information and interprets the meaning. By so doing, a user can easily enjoy services anytime, anywhere that are adapted to suit his or her own status and location. Furthermore, a differentiated service strategy can be devised by using independent cloud services.

A system for distributing customized cloud services under a SLA, and a method for the same, according to the present invention is explained more specifically as below.

The present invention can further include recognizing a service status with user context information analyzed and selecting a service item, through the service recognizing module.

The present invention can further include recording, and converting into an image, through the user image converting module, the level of the use of the customized cloud service provided as virtualized, and transmitting it, through the service transmitting module, to a service device with the virtualized cloud service incorporated.

The present invention can further include recognizing, through the service event recognizing module, user's movements associated with the operations of a keyboard, a mouse or a touch device, etc., which arise from the use of the cloud service.

The present invention can further include defining, through the relationship defining module, the relationship between classified context information in order to infer the context of the user, extracting, through the meaning defining module, data having priority, which affects service behaviors, by analyzing the relationship generated from the context information, and inferring, through the domain mapping module, the service behaviors that can exist in the user context data and mapping the information.

The present invention can further include defining, and symbolizing, through the service level defining module, the service structures level by level that result from the user context information, analyzing, through the instance data analyzing module, the information of a service software that results from the cloud server and of the data structure used, and connecting, through the software matching module, a service software that suits the user context from the cloud server.

For example, a system and method for distributing customized cloud services under a SLA according to the present invention is to provide customized cloud services that suit a user's service device and the status of use. Because a cloud computing service provided under a SLA provides individuals with services having the same structure, a service is provided by a process of determining and providing services classified user by user, a process of encoding and decoding the context information of a user recognized via network in order to collect and transmit the information, and a process of multiple-context-recognizing and service-defining for defining each service level in order to provide cloud virtualization service customized for each individual.

The present invention can be applied to a variety of individualized services, or can be used in other applications, such as a service combining the real-time determination of the status of a car by means of a real-time interface with a touch screen combined with images on a smart phone, the immediate maintenance of the car in a service center, the reservation for a service use, and the status of the car.

The illustration above is to exemplify the present invention, and can thus be corrected, modified, or replaced in a variety of ways within the intended scope of the invention by a person having an ordinary skill in the art to which the present invention pertains. The accompanying drawings are not intended to limit the scope of the present invention, but to illustrate it. The scope of the present invention is by no means restricted by the accompanying drawings. The protection of the present invention is defined by the accompanying claims, and all other inventions equivalent to the present invention falls within the scope of the present invention.

### DESCRIPTION OF REFERENCES

100: Packet Module
110: Context Information Collecting Module
120: Context Information Packet Constituting Module
200: Encoding
210: Context Information Keystone Constituting Module
220: Context Information Encoding Module
230: Context Information Compressing Module
300: Decoding
400: Data Management Module
410: User Management DB
420: System Log Management
430: Data Key Management
440: Service Key Management
450: Virtualization Key Management
500: Information Classifying Module
510: Context Information Classifying Module
520: Context Information Pattern Analyzing Module
530: Context Information Pattern Matching Module
540: Context Information Domain Mapping Module
600: Context Defining Module
610: Context Information Ontology Module
620: Relationship Defining Module
630: Pattern Extracting Module
640: Meaning Defining Module
650: Domain Mapping Module
700: SLA Defining Module
710: Service Ontology Module
720: Service Level Defining Module
730: Instance Data Analyzing Module
740: Service Mapping Module
750: Software Matching Module
800: Virtualization Module
890: Virtualization Management

What is claimed is:

1. A system of multiple context-awareness for distributing a customized cloud service under a SLA, the system comprising:
a packet module constituting a packet for providing the context information of a user;
a data managing module for using the context information received from the user and managing the service information determined, and for classifying and managing the context information of the user;
a user context information classifying module for classifying and analyzing the context information transmitted from the user;
a context defining module for defining the context information as validated data;
a SLA defining module for defining a service level that suits for the context information; and
a virtualization module for providing the user with a service item that has been selected by constituting a cloud virtualization service.

2. The system according to claim 1, further comprising a mass data distribution managing module for managing, in real time, the context information and image data of the user that have been served.

3. The system according to claim 1, further comprising a service recognizing module for recognizing a service status with the analyzed context information of the user and selecting a service item.

4. The system according to claim 1, further comprising:
a user image converting module for recording the use level of the customized cloud service that is provided as virtualized and for converting it to an image; and
a service transmitting module for transmitting data including the virtualized cloud service to the user device.

5. The system according to claim 1, further comprising a service event recognizing module for recognizing the movement of a user using such a device as a keyboard, a mouse, or a touch device that arises from the operation of the cloud service.

6. The system according to claim 1, wherein the context defining module comprises:
a relationship defining module for defining the relationship between context information classified to infer the user context;
a meaning analyzing module for extracting priority data, which affect service behaviors, by analyzing the relationship resulting from the context information; and
a domain mapping module for inferring the service behaviors that can exist in the user context data and for mapping the information.

7. The system according to claim 1, wherein the SLA defining module comprises:
a service level defining module for defining, and symbolizing, the service structures level by level that result from the user context information;
an instance data analyzing module for analyzing the information of a service software that results from the cloud server and of the data structure used; and
a software matching module for connecting a service software that suits the user context from the cloud server.

8. A system, and a method, for distributing a customized cloud service under a SLA, the system and the method comprising:
collecting and providing, through a packet module, the context information of a user;
encoding and decoding, through a encoding/decoding module, the packet transmitted;
managing, through a data managing module, the service information determining by using the context information received from the use, and classifying and managing, through the data managing module, the context information of the user;
classifying, a user context information classifying module, the context information transmitted from the user for analysis;
defining the context information as validated data through a context defining module;
defining a service level that suits for the context information through a SLA defining module for; and
providing, through a virtualization module, the user with a service item that has been selected by constituting a cloud virtualization service.

9. The system and the method according to claim 8, further comprising recognizing a service status with user context information analyzed and selecting a service item, through a service recognizing module.

10. The system and the method according to claim 8, further comprising:
recording, and converting into an image, through a user image converting module, the level of the use of the customized cloud service provided as virtualized; and
transmitting it, through a service transmitting module, to a service device with the virtualized cloud service incorporated.

11. The system and the method according to claim 8, further comprising recognizing, through a service event recognizing module, user's movement associated with the operation of such a device as a keyboard, a mouse or a touch device, which arises from the use of the cloud service.

12. The system and the method according to claim 8, further comprising:
defining, through a relationship defining module, the relationship between classified context information in order to infer the context of the user;
extracting, through a meaning defining module, data having priority, which affects service behaviors, by analyzing the relationship generated from the context information; and
inferring, through a domain mapping module, the service behaviors that can exist in the user context data and mapping the information.

13. The system and the method according to claim 8, further comprising:
defining, and symbolizing, through a service level defining module, the service structures level by level that result from the user context information;
analyzing, through an instance data analyzing module, the information of a service software that results from the cloud server and of the data structure used; and
connecting, through a software matching module, a service software that suits the user context from the cloud server.
